(19) United States
(12) Patent Application Publication
(10) Pub. No.: US 2004/0148991 A1
(43) Pub. Date: Aug. 5, 2004

(54) Method and apparatus for dissolving urea

(76) Inventors: Sabeto DiRoma, Oakdale, CT (US); Robert Roach, East Greenwich, RI (US); Frank Recchia, New Haven, CT (US)

Correspondence Address: LAW OFFICES OF RAYMOND A. NUZZO, LLC, 579 THOMPSON AVENUE, EAST HAVEN, CT, 06512, US

(21) Appl. No.: 10/749,072

(22) Filed: Dec. 30, 2003

Related U.S. Application Data
(60) Provisional application No. 60/438,024, filed on Jan. 3, 2003.

(51) Int. Cl. C05C 9/00; B01D 11/02

(52) U.S. Cl. 71/28; 71/64.06; 422/261; 422/269

(57) ABSTRACT

A method and apparatus for dissolving urea. In one embodiment, the method comprises the steps of providing a mixing container, depositing a predetermined amount of urea into the mixing container, and depositing a predetermined amount of water into the mixing chamber to achieve a predetermined urea/water concentration. In a preferred embodiment, the predetermined urea/water concentration is about 50/50 wt/wt. The method further comprises the steps of mixing the urea and water to form a mixture, allowing the mixture to stand until the temperature of the mixture reaches a predetermined temperature, and thereafter, resuming mixing of the mixture until the urea completely dissolves in the water.

### CROSS-REFERENCE TO RELATED APPLICATION

This application claims the benefit of commonly owned and copending U.S. provisional patent application No. 60/438,024, filed Jan. 3, 2003.

### BACKGROUND OF THE INVENTION

1. Field of the Invention

The present invention relates to a method and apparatus for dissolving urea.

2. Problem to be Solved

U.S. Pat. Nos. 4,610,714 and 4,710,360 describe a method and apparatus for dissolving urea without the use of fossil fuel-derived heat. However, the method and apparatus described in these patents are complex and require expensive equipment and machinery. Such equipment and machinery consumes a significant amount of electrical energy. Furthermore, these patents disclose that it is preferred if the method described therein is implemented in warm climate areas. Additionally, the method and apparatus disclosed in the aforementioned patents may need more than one person to operate the apparatus.

Another prior art technique is to mix the urea with hot water. However, such a technique consumes significant amounts of electrical energy as well as fossil fuel sources in order to heat the water.

Another disadvantage of prior art methods and techniques is the production of ammonia by-products that typically result from the heating of the urea in water to relatively high temperatures (e.g. 130° F., 200° F.) in order to accelerate the solution process to prepare commercial truckload quantities (e.g. 45,000 lbs. of 50% urea solution).

What is needed is a new and improved method and apparatus for dissolving urea.

### SUMMARY OF THE INVENTION

Bearing in mind the problems and deficiencies of the prior art, it is an object of the present invention to provide an improved method and apparatus for dissolving urea that eliminates the problems associated with the prior art techniques discussed in the foregoing description.

It is another object of the present invention to provide a new and improved method and apparatus for dissolving urea that does not require directly heating the water or urea.

It is a further object of the present invention to provide a new and improved method and apparatus for dissolving urea that does not require expensive or complex equipment and machinery.

It is another object of the present invention to provide a new and improved method and apparatus for dissolving urea that utilizes relatively less electrical energy than prior art techniques.

It is a further object of the present invention to provide a new and improved method and apparatus for dissolving urea that can be used in warm or cool climates.

Other objects and advantages of the present invention will be apparent from the ensuing description.

In one aspect, the present invention is directed to a method for dissolving urea. In one embodiment, the method comprises the steps of providing a mixing container, depositing a predetermined amount of urea into the mixing container, and depositing a predetermined amount of water into the mixing container. The predetermined amounts of water and urea form a predetermined urea/water concentration. In one embodiment, the predetermined urea/water concentration is about 50/50 wt/wt. The method further comprises the steps of mixing the urea and water to form a mixture, allowing the mixture to stand for a predetermined amount of time, and thereafter, mixing the mixture until the urea completely dissolves in the water.

In a related aspect, the present invention is directed to a method for dissolving urea comprising providing a mixing container, depositing a predetermined amount of urea and a predetermined amount of water into the mixing container to yield a predetermined urea/water concentration, mixing the urea and the water to form a mixture, monitoring the temperature of the mixture, allowing the mixture to stand until the temperature of the mixture reaches a predetermined temperature, and thereafter, resuming mixing of the mixture until the urea completely dissolves in the water. In one embodiment, the predetermined urea/water concentration is about 50/50 wt/wt. The method further includes maintaining the temperature of the mixture in the mixing container at the predetermined temperature. The predetermined temperature is between about 19° C. and 24° C.

In another aspect, the present invention is directed to an apparatus for dissolving urea comprising a mixing container, a urea dispensing device for depositing a predetermined amount of urea into the mixing container, a water dispensing device for depositing a predetermined amount of water into the mixing container, a temperature sensor to measure the temperature of the mixture within the mixing container, a temperature control system for maintaining the temperature of the mixture at a predetermined temperature, and a control system to control (i) the urea and water dispensing devices to deposit predetermined amounts of water and urea into the mixing container to form a predetermined urea/water concentration, (ii) the mixing container to mix the urea and the water to form a mixture, (iii) the mixing container to cease mixing to allow the mixture to stand for a predetermined amount of time, (iv) the sensor to provide data representing the temperature of the mixture, (v) the temperature control system to maintain the temperature of the mixture at a predetermined temperature, and (vi) the mixing container to resume mixing of the mixture when the temperature of the mixture reaches a predetermined temperature and continue such mixing until the urea completely dissolves in the water to form a solution.

### BRIEF DESCRIPTION OF THE DRAWINGS

FIG. 1 is a block diagram of an apparatus, in accordance with one embodiment of the present invention, for carrying out the method of the present invention.

FIG. 2 is a curve of the dissolution time of urea for various amounts of water initially added to the urea.

FIG. 3 is a block diagram of an apparatus, in accordance with another embodiment of the present invention, for carrying out the method of the present invention.

### DETAILED DESCRIPTION OF THE INVENTION

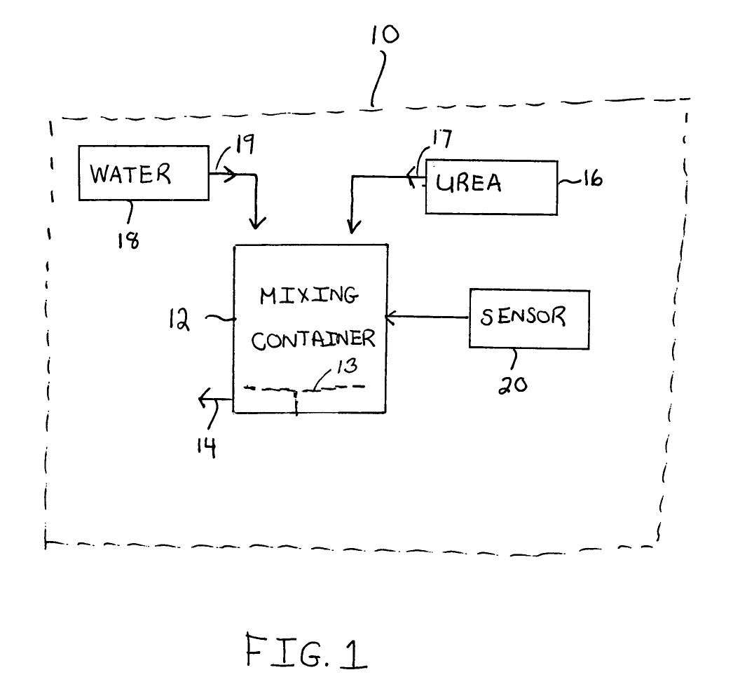

Referring to FIG. 1, there is shown apparatus 10 of the present invention. Apparatus 10 generally comprises mixing container or vat 12 that has a motor-driven mixing blade 13, shown in phantom. In one embodiment, mixing container 12 is enclosed. In another embodiment, mixing container 12 has an open top. Mixing container 12 includes outlet 14 for outputting the product solution. Mixing container 12 can be configured to be of any suitable size depending on the amount of the solution that is required. In one embodiment, outlet 14 comprises an electrically controlled output valve. Manual stirring can be used in place of mixing blade 13. Apparatus 10 includes urea dispensing device 16 that dispenses a predetermined amount of urea into mixing container 12. In one embodiment, urea dispensing device 16 includes electrical controlled output valve 17 to output the desired amount of urea. Apparatus includes water dispensing device 18. Water dispensing device 18 comprises outlet 19 that dispenses a predetermined amount of water into mixing container 12. In one embodiment, outlet 19 comprises an electrically controlled output valve. In accordance with the present invention, the water in water dispensing apparatus 18 is maintained at room temperature. This feature is described in detail in the ensuing description.

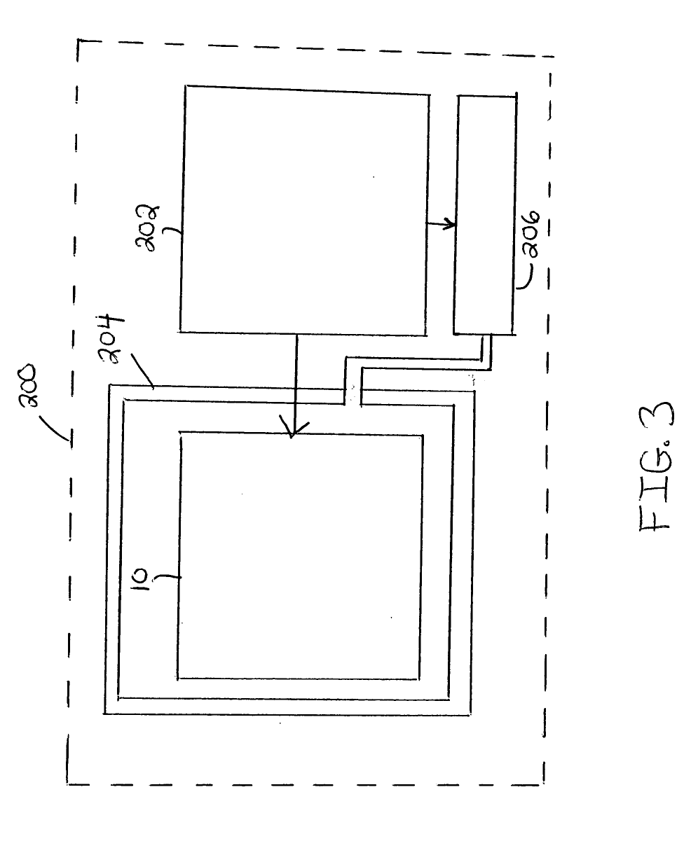

Referring to FIG. 1, apparatus 10 further includes temperature sensor 20 for monitoring the temperature of the urea/water mixture in mixing container 12. In one embodiment, all components of apparatus 10 are electronically controlled by an electronic control system. Such an embodiment is shown in FIG. 3 and discussed in detail in the ensuing description.

The first step of the method of the present invention is to add a predetermined amount of urea prills to mixing container 12. Thus, urea dispensing device 16 outputs the desired amount of urea prills to mixing container 12. Next, water dispensing device 18 outputs a predetermined amount of water to mixing container 12 so as to achieve a predetermined urea/water concentration. In a preferred embodiment, the predetermined urea/water concentration is 50/50 wt/wt. For example, if 40 grams of urea prills are deposited into mixing container 12, then 40 grams (or ml) of water are added to the urea prills to achieve a 50/50 wt/wt urea/water concentration. The predetermined urea/water concentration may be other than a 50/50 wt/wt concentration. The actual predetermined urea/water concentration may depend upon the amounts of urea and water being used as well as the particular application at hand. Furthermore, although the foregoing description is in terms of the urea prills being deposited first to mixing container 12, it is to be understood that the water may be deposited first into mixing container 12 and then followed by the urea prills.

The next step of the method of the present invention comprises mixing the urea prills and the water so as to form a mixture. After the mixture is formed, the mixture of urea and water is then allowed to stand for an amount of time sufficient to allow the temperature of the mixture to reach a predetermined temperature. In a preferred embodiment, the predetermined temperature is between about 19° C. and 24° C., and more preferably, about 23° C. The amount of time required for the temperature of the mixture to reach the predetermined temperature depends upon the amount of mixture in mixing container 12. During this time period in which the mixture is allowed to stand, the temperature of the mixture is monitored with temperature sensor 20. When the temperature of the mixture reaches the predetermined temperature, mixing of the urea/water mixture is resumed and continues until the urea completely dissolves in the water. The time for urea dissolution is measured from the moment the mixing resumes to the point in time when the urea becomes completely dissolved in the water. The solution is outputted from mixing container 12 via outlet 14.

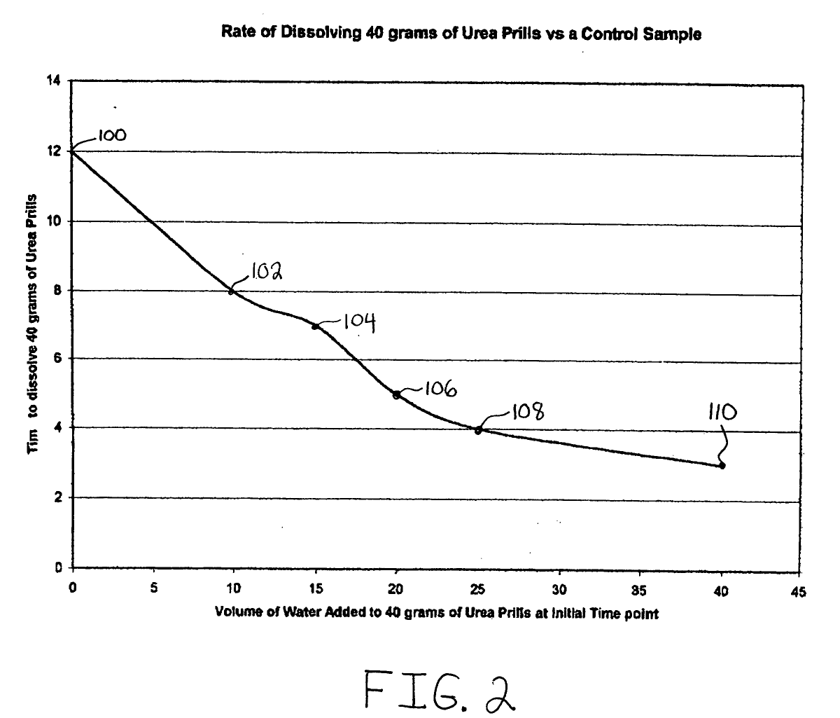

It has been found that increasing the volume of water initially added to the urea prills substantially decreases the time for the urea to completely dissolve in the water after a urea/water concentration of 50/50 wt/wt is achieved. A series of tests were conducted in order to determine the urea dissolution time when various amounts of water were initially added to the urea and wherein additional amounts of water were subsequently added to attain the 50/50 wt/wt urea/water concentration. A control test was first conducted in order to obtain reference data. About 40 grams of urea prills were mixed with an equal amount of water, i.e. 40 grams (or milliliters). The mixture was not allowed to stand for any amount of time. Thus, the mixing step began as soon as 40 grams of urea and 40 grams of water were added to mixing container 12. The time for the urea to completely dissolve was about twelve (12) minutes and is indicated by numeral 100 in the curve of FIG. 2.

### Test 1

In the first test, about 40 grams of urea and 10 grams of water were deposited into mixing container 12. The mixture was then mixed or stirred, and allowed to stand until the temperature of the mixture reached about room temperature or about 23° C. Next, an amount of water necessary to achieve a urea/water concentration of 50/50 wt/wt was added to the mixture. Since the initial amount of water was 10 grams , 30 grams of water were added to the mixture to achieve the desired 50/50 wt/wt concentration. The urea and water were mixed again. The urea completely dissolved in eight (8) minutes after the 50/50 wt/wt urea/water concentration was achieved. This is indicated by numeral 102 on the curve in FIG. 2. The dissolution time was about 33% faster than the control test dissolution time of twelve (12) minutes.

### Test 2

In the next test, about 40 grams of urea and 15 grams of water were deposited into mixing container 12. The mixture was then mixed or stirred, and allowed to stand until the temperature of the mixture reached about room temperature or about 23° C. Next, an amount of water necessary to achieve a 50/50 wt/wt urea/water concentration was added to the mixture. Since the initial amount of water was 15 grams, 25 grams of water were added to the mixture to achieve the desired 50/50 wt/wt urea/water concentration. The urea and water were mixed again. The urea completely dissolved in seven (7) minutes after the 50/50 wt/wt urea/water concentration was achieved. This is indicated by numeral 104 on the curve in FIG. 2. The dissolution time was about 42% faster than the control test dissolution time of twelve (12) minutes.

### Test 3

In the next test, about 40 grams of urea and 20 grams of water were deposited into mixing container 12. The mixture was then mixed or stirred, and allowed to stand until the temperature of the mixture reached about room temperature or about 23° C. Next, an amount of water necessary to achieve a urea/water concentration of 50/50 wt/wt was added to the mixture. Since the initial amount of water was 20 grams, 20 grams of water were then added to the mixture to achieve the desired 50/50 wt/wt urea/water concentration. The urea and water were mixed again. The urea completely dissolved in five (5) minutes after the 50/50 wt/wt urea/water concentration was attained. This is indicated by numeral 106 on the curve in FIG. 2. The dissolution time was about 58% faster than the control test dissolution time of twelve (12) minutes.

### Test 4

In the next test, about 40 grams of urea and 25 grams of water were deposited into mixing container 12. The mixture was then mixed or stirred, and allowed to stand until the temperature of the mixture reached about room temperature or about 23° C. Next, an amount of water necessary to achieve a urea/water concentration of 50/50 wt/wt was added to the mixture. Since the initial amount of water was 25 grams, 15 grams of water were added to the mixture to achieve the desired 50/50 wt/wt urea/water concentration. The urea and water were mixed again. The urea completely dissolved in four (4) minutes after the 50/50 wt/wt urea/water concentration was attained. This is indicated by numeral 108 on the curve in FIG. 2. The dissolution time was about 67% faster than the control test dissolution time of twelve (12) minutes.

### Test 5

In the last test, 40 grams of urea and 40 grams of water were added to mixing container 12 so as to produce a 50/50 wt/wt concentration of urea and water. The urea prills and water were then mixed or stirred and allowed to stand until the temperature of the mixture reached about room temperature or about 23° C. As soon as the temperature of the mixture reached about room temperature or about 23° C., the mixture was mixed or stirred again. The urea completely dissolved in three (3) minutes after a urea/water concentration of 50/50 wt/wt was achieved. This is indicated by numeral 110 on the curve in FIG. 2. This dissolution time was about 75% faster than the control test dissolution time of twelve (12) minutes.

Although the ensuing description of TESTS 1-5 were in terms of allowing the mixture to stand until the desired temperature of the mixture reached about room temperature or 23° C., it is to be understood that the desired temperature can be any suitable temperature in between about 19° C. and 24° C.

Thus, by increasing the volume of water initially added to the urea prills, the time for the urea to completely dissolve in the water substantially decreases once a 50/50 wt/wt urea/water concentration is attained.

Referring to FIG. 3, there is shown another embodiment of the present invention. Apparatus 200 generally comprises apparatus 10, described previously herein and shown in FIG. 1, and electronic control system 202. In one embodiment, electronic control system 202 comprises a computer having a data input interface, such as a computer keyboard, to allow users to input control data. Electronic control system 202 is in electrical signal communication with output valves 17 and 19 of urea dispensing device 16 and water dispensing device 18, respectively, so as to control the output flow of these devices. Electronic control system 202 is in electrical signal communication with mixing container 12 to control mixing blades 13. Electronic control system 202 is also in electrical signal communication with outlet 14 to control the flow of solution from mixing container 12. Electronic control system 202 is also in electrical signal communication with sensor 20. Specifically, electronic control system 202 receives temperature data from sensor 202 which represents the temperature of the mixture in mixing container 12 and is programmed to control mixing blades 13 to resume mixing when the temperature of the mixture reaches the desired predetermined temperature. Electronic control system 202 comprises timing circuitry that also tracks the time in which a mixture of urea and water is allowed to stand before mixing blades 13 are activated and mixing of the mixture resumes.

In a preferred embodiment, apparatus 10 is located within a controlled environment so as to prevent significant climatic temperature deviations from having deleterious effects on the dissolution of urea in the water. For example, as shown in FIG. 3, apparatus 10 is located in enclosed room 204. Enclosed room 204 preferably has suitable insulation to facilitate maintaining a constant temperature within room 204. Electronic control system 202 is located outside of enclosed room 204. Enclosed room 204 may be heated or cooled as needed by temperature control system 206. Temperature control system 206 may be configured with any commercially available heating or cooling means, e.g. air conditioning, furnace, etc. In one embodiment, a feedback loop is employed wherein electronic control system 202 receives temperature data from sensor 20 and then controls temperature control system 206 to maintain the temperature within enclosed room 204 at a desired temperature (e.g. room temperature).

It is to be understood that the actual amounts of urea, water, and desired solution can be varied depending upon the application. The foregoing description shall not be construed as limiting the invention to the relatively small amounts of urea, water and solution described in the foregoing description. Thus, the present invention may be used with significantly large amounts of water and urea to produce a significantly large amount of solution.

It is to be understood that the predetermined urea/water concentration can be other than 50/50 wt/wt. Specifically, the predetermined amounts of urea and water may be varied so as to achieve a urea/water concentration other than 50/50 wt/wt provided that the percent urea does not exceed 50% of the total weight of the predetermined urea/water concentration in order to ensure that the urea completely dissolves in the water at room temperature (i.e. 23° C.). For example, a predetermined amount of urea may be mixed with a predetermined amount of water so as to achieve a urea/water concentration of 45/55 wt/wt. In another example, a predetermined amount of urea may be mixed with a predetermined amount of water so as to achieve a urea/water concentration of 35/65 wt/wt. The desired urea/water concentration may be varied depending upon the particular application at hand.

Although the foregoing description is in terms of the urea prills being added to mixing container 12 first and the water being added thereafter, it is to be understood that the water may be added first to mixing container 12 and the urea prills added thereafter.

The present invention provides many advantages and benefits, namely:

a) the water with which the urea prills is mixed does not have to be separately and directly heated, thereby reducing the overall energy consumption in implementing the method of the present invention;

b) the rate at which the urea prills dissolve in the water is at least 60% faster than the prior art technique of mixing the urea with hot water without allowing the mixture to stand;

c) complex and expensive equipment and machinery are not required; and

d) the present invention substantially eliminates the production of ammonia by-products that typically occur in prior art methods and techniques which heat the urea in water to relatively high temperatures (e.g. 130° F., 200° F.).

The principles, preferred embodiments and modes of operation of the present invention have been described in the foregoing specification. The invention which is intended to be protected herein should not, however, be construed as limited to the particular forms disclosed, as these are to be regarded as illustrative rather than restrictive. Variations in changes may be made by those skilled in the art without departing from the spirit of the invention. Accordingly, the foregoing detailed description should be considered exemplary in nature and not limited to the scope and spirit of the invention as set forth in the attached claims.

What is claimed is:

1. A method for dissolving urea, comprising:
providing a mixing container;
depositing a predetermined amount of urea and a predetermined amount of water into said mixing container to yield a predetermined urea/water concentration;
mixing said urea and said water to form a mixture;
monitoring the temperature of the mixture;
allowing the mixture to stand until the temperature of the mixture reaches a predetermined temperature; and
thereafter, resuming mixing of the mixture until the urea completely dissolves in the water.

2. The method according to claim 1 wherein the predetermined urea/water concentration is about 50/50 wt/wt.

3. The method according to claim 1 wherein the predetermined amount of urea that is in the predetermined urea/water concentration does not exceed 50% of the total weight of the predetermined urea/water concentration.

4. The method according to claim 1 further including maintaining the temperature of the mixture in the mixing container at the predetermined temperature.

5. The method according to claim 1 wherein the predetermined temperature is between about 19° C. and 24° C.

6. The method according to claim 1 wherein the predetermined temperature is about 23° C.

7. A method for dissolving urea, comprising:
providing a mixing container;
depositing an amount of urea into said mixing container;
depositing an amount of water into said mixing chamber, the amount of water being equal to the amount of urea to yield a urea/water concentration of about 50/50 wt/wt;
mixing said urea and said water to form a mixture;
monitoring the temperature of the mixture;
allowing the mixture to stand until the temperature of the mixture reaches a predetermined temperature; and
thereafter, resuming mixing of the mixture until the urea completely dissolves in the water.

8. An apparatus for dissolving urea, comprising:
a mixing container;
a urea dispensing device for depositing a predetermined amount of urea into said mixing container;
a water dispensing device for depositing a predetermined amount of water into said mixing container;
a temperature sensor to measure the temperature of mixture within said mixing container;
a temperature control system for maintaining the temperature of the mixture at a predetermined temperature;
a control system to control (i) said urea and water dispensing devices so as to deposit predetermined amounts of water and urea into said mixing container to form a predetermined urea/water concentration, (ii) said mixing container to mix the urea and the water to form a mixture, (iii) said mixing container to cease mixing to allow the mixture to stand for a predetermined amount of time, (iv) said sensor to provide data representing the temperature of the mixture, (v) said temperature control system to maintain the temperature of the mixture at a predetermined temperature, and (vi) said mixing container to resume mixing of the mixture when the temperature of the mixture reaches a predetermined temperature and continue such mixing until the urea completely dissolves in the water to form a solution.

9. The apparatus according to claim 8 wherein said control system is configured to control the said urea and water dispensing devices to deposit predetermined amounts of urea and water such that said predetermined urea/water concentration is about 50/50 wt/wt.

10. The apparatus according to claim 8 wherein said control system is configured to control the said urea and water dispensing devices to deposit predetermined amounts of urea and water into said mixing container such that the predetermined amount of urea does not exceed 50% of the total weight of the predetermined urea/water concentration.

11. The apparatus according to claim 8 further comprising an enclosed room in which is located said urea and water dispensing devices, said mixing container and said temperature sensor, and wherein said control system and said temperature control system are located outside of said enclosed room.

12. The apparatus according to claim 8 wherein said water and urea dispensing devices and said mixing container have electrically controlled outlet valves that are in electrical signal communication with said control system.

13. The apparatus according to claim 8 wherein said control system comprises a computer.

14. The apparatus according to claim 13 wherein said computer is programmed to control said mixing container to resume mixing when the temperature of the mixture is about 23° C.
